(19) United States
(12) Patent Application Publication
(10) Pub. No.: US 2009/0165068 A1
(43) Pub. Date: Jun. 25, 2009

(54) NETWORK VIDEO SYSTEM FOR A TELEVISION TO BROADCAST A COMPUTER NETWORK VIDEO PROGRAM

(76) Inventors: Kuo-Lung Chang, Junghe City (TW); Yi-Ju Chen, Junghe City (TW); Hsing-Yung Wang, Junghe City (TW)

Correspondence Address: SINORICA, LLC, 2275 Research Blvd., Suite 500, ROCKVILLE, MD, 20850, US

(21) Appl. No.: 12/180,618

(22) Filed: Jul. 28, 2008

(30) Foreign Application Priority Data
Dec. 24, 2007 (TW) 96149615

(51) Int. Cl. H04N 7/173

(52) U.S. Cl. 725/110

(57) ABSTRACT

A network video system for a television to broadcast a computer network video program includes a peer-to-peer (P2P) video service platform, a computer, a network video decoder, and a television. The P2P video service platform further includes at least a video server, at least a commercial server, and a plurality of peers. The computer forms a P2P network connection with the P2P video service platform so as to download at least one video stream from the video server or the peers and at least one commercial stream from the commercial server. The network video decoder forms a local network connection with the computer so as to receive the video streams and the commercial streams downloaded to the computer. The television is coupled electrically with the network video decoder to display the video streams and the commercial streams received by the network video decoder.

This application claims the benefit of Taiwan Patent Application Serial No. 96149615, filed Dec. 24, 2007, the subject matter of which is incorporated herein by reference.

### BACKGROUND OF THE INVENTION

(1) Field of the Invention

The invention relates to a network video system, and more particularly to the network video system which can broadcast and/or display a computer network video program on a television.

(2) Description of the Prior Art

Thanks to recent internet development and advanced digital technology, a variety of music, films and movies can be digitalized and be easily transmitted to computers at user ends through internet.

Among various network video data transmissions, the peer-to-peer (P2P) stream broadcasting is a popular one that can provide real-time video service. In a P2P stream broadcasting, a video stream is cut into plural tagged packets. The packets are orderly uploaded to a P2P network. Then, a computer user can download the packets orderly from one of his/her peers in the same P2P network, decode the packets individually, and broadcast the decoded packets (i.e. sections of the video stream). During the downloading, while in broadcasting one packet, a following packet is downloaded to the computer. The process won't be stopped until the final packet is downloaded. Upon such an arrangement, the video stream can be completely broadcasted at the computer end. In particular, the video stream provided over the P2P network can be called as a computer network video program.

Referring to FIG. 1, a framework of a conventional P2P stream broadcasting is shown. The conventional P2P stream broadcasting includes a P2P video service platform 10, a video server 12, a plurality of peers 14 and a computer 16.

The P2P video service platform 10 is usually provided by the network video program provider, in a form of a website page on the browser of the computer 16, or as a stream broadcast software installed in the computer 16. In the case that the platform 10 is formed as a website page, the website page should also function the stream broadcasting.

Through the P2P video service platform 10, the P2P video server 12, the peers 14 and the computer 16 are integrated to a P2P network. Herein, the peer 14 is a digital processing equipment, such as another computer, to connect with the video server 12 or to download the same video stream as the computer will do.

The video server 12 capable of streaming includes at least a video stream 121, an encode module 123 and a stream module 125. The video stream 121 can be a TV program (for example, an online news), or a ready-to-play video stream (for example, a movie film). No matter what kind of the video stream 121 is, it is a digitalized data. Thus, the encode module 123 can cut and zip the video stream 121 into a plurality of packets, and each header of the individual packet is tagged by a respective serial number.

As soon as the video server 12 receives a request from the computer 16 or any of the peers 14, the stream module 125 forwards orderly the packets by data streaming. The computer 16 can then download a specific packet from the video server 12 or any of the peers 14. The downloaded packet is then unzipped and stream broadcasted. To the computer 16 or any of the peers 14 in the P2P network, uploading packets to other peers can also be performed. Therefore, more participants in the P2P video service platform 10 would imply an increase in the rate of the data streaming, and thereby the video quality through the streaming would be better ensured.

Nevertheless, in the art, the video stream 121 can be played only on the screen of the computer 16, not on a TV screen. This is the reason why the computer network video programs can't be popular. If a user want to play a computer network video program on a TV screen, he/she needs to move the computer to neighbor closely enough the TV set and bridge the computer to the VGA conjunction port of the TV set. However, not every TV set provides a VGA conjunction port. Further, moving the computer and cabling in between with the TV set are obviously inconvenient to the user.

Therefore, to provide a noble system capable of playing the computer network video program on the TV screen would be welcome to the audiences and may make popular the computer network video programs.

### SUMMARY OF THE INVENTION

Accordingly, it is an object of the present invention to provide a network video system for a television to broadcast a computer network video program.

In the present invention, the network video system includes a peer-to-peer (P2P) video service platform, at least a video server, at least a commercial server, a computer, a plurality of peers, a network video decoder, and a TV set.

The P2P video service platform forms a P2P network connection with the video server, the commercial server, the computer and all the peers. Thereby, the computer can download, in a P2P pattern, video streams from the video server or any of the peers through the P2P video service platform, or commercial streams from the commercial server or any of the peers.

The video server as a server capable of data streaming includes at least a video stream. For a video stream is usually a huge file, it is necessary, before a transmission, that the video stream is segmented and zipped into a plurality of packets in advance. Each of the packets has a header footnoted with a serial number. In the case that the video server receives a request from the computer or any of the peers, the packets of the requested video stream are transmitted orderly in a streaming pattern. The computer can download a packet with a specific serial number from the video server or the peer. In the present invention, more participants with the P2P video service platform implies definitely a hike in the rate of the data streaming, and thus the video quality through the streaming can be better ensured.

The commercial server, as another server capable of data streaming similar to the aforesaid video server, includes at least a commercial stream, which can be segmented and zipped into a plurality of packets and can be further transmitted to the computer or any of the peers in a streaming pattern. The major difference between the video server and the commercial server is that the commercial server would transmit the commercial stream to the computer or the peers automatically, while the video server can transmit the video stream only upon a request.

The network video decoder, connected with the computer via a local network, is to control the computer to download the packets from the P2P network platform, to receive the downloaded packets, and finally to unzip and play the video stream. In the present invention, each of the packets can include a segment of the video stream and a segment of the commercial stream. The television is electrically coupled with the network video decoder. Upon such an arrangement, the video stream as well as the commercial stream can be displayed on the screen of the television.

To promote the commercial stream without degrading the display quality of the video stream, the network video decoder can overlap, by a crystal or semi-transparent way, the display of the commercial stream on top of the display of the video stream; such that the commercial stream and the video stream can be displayed simultaneously on the same TV screen. Preferably, the commercial stream can be played in a traffic line way flowing along a side of the display screen.

Further, for the size of the video stream is usually larger than that of an ordinary commercial stream, a much longer time in pre-buffering before been displayed is needed. During the pre-buffering, the video stream is unable to be shown on the TV screen. At this moment, in the present invention, the network video decoder can automatically display the commercial video on the TV screen.

In addition, when the number of the participants with the P2P video service platform increases, it can be expected that more video streams can be available in the network. To facilitate the search of a specific video stream, the P2P video service platform can further include an electronic program list. As soon as a computer is successfully connected with the P2P video service platform, the electronic program list would be automatically provided to the computer, so as the commercial streams. Upon such an arrangement, when a user goes over the electronic program list, the commercial stream can be automatically presented to the user.

Furthermore, to ease the operation of the system, a remote control is provided to control the network video decoder. The remote control can provide a plurality of hot keys to be respectively in charge of specific commands to the computer; such as a command of entering the electronic program list of the P2P video service platform, a command of displaying the selected program in the electronic program list, and so on.

In the present invention, each of the commercial streams in commercial server can have a commercial code. In the case that a TV user is interested in a specific product promoted by a commercial stream, he/she can use the remote control to enter the respective commercial code and can then press a corresponding hot key to have the network video decoder notify the related commercial server through the computer. The related commercial server is then in response to issue an email related to the corresponding commercial stream to an email address preset by the TV user.

All these objects are achieved by the network video system for a television to broadcast a computer network video program described below.

### BRIEF DESCRIPTION OF THE DRAWINGS

The present invention will now be specified with reference to its preferred embodiment illustrated in the drawings, in which:

FIG. 1 is a schematic view of a framework of a conventional P2P stream broadcasting;

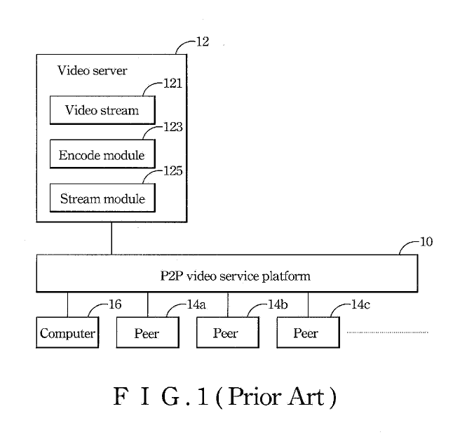

FIG. 2 is a schematic view of a preferred framework of a network video system for a television to broadcast a computer network video program in accordance with the present invention;

FIG. 3A shows schematically signal flows of a video packet and a commercial packet in accordance with the present invention;

FIG. 3B shows, in accordance with the present invention, how a commercial stream can be displayed on a TV screen while in buffering a video stream; and

FIG. 3C shows a typical electronic program list in accordance with the present invention.

### DESCRIPTION OF THE PREFERRED EMBODIMENT

The invention disclosed herein is directed to a network video system for a television to broadcast a computer network video program. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

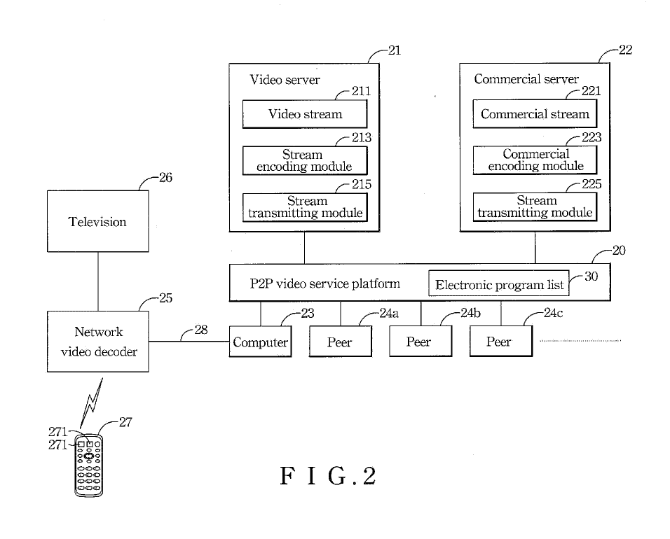

Referring now to FIG. 2, a preferred framework of a network video system for a television to broadcast a computer network video program in accordance with the present invention is schematically shown. The system includes a P2P video service platform 20, at least a video server 21, at least a commercial server 22, a computer 23, a plurality of peers 24 to the computer 23, a network video decoder 25, a TV set 26 and a remote control 27.

The P2P video service platform 20, usually provided by network video program suppliers, can be a webpage or a stream broadcast software installed in the computer 23. If it is a webpage, the webpage shall be able to proceed stream broadcasting. The computer 23 can forms a P2P network connection with the video server 21, the commercial server 22, and possible all the peers 24 through the P2P video service platform 20.

The video server 21 as a server capable of data streaming includes at least a video stream 211. The video stream 211 can be a TV program (an online news for example) provided by a TV station, a pre-recorded video stream (a movie for example), or any the like. Anyhow, the video stream 211 is a digitalized file that can be divided and zipped into a plurality of packets by a stream encoding module 213. Each of the packets has a header to footnote a corresponding serial number.

In the case that the video server 21 receives a request from the computer 23 or any of the peers 24, the packets of the requested video stream are transmitted orderly in a streaming pattern by a streaming module 215. The computer 23 can download a packet with a specific serial number from the video server 21 or any of the peers 24. In the present invention, more participants with the P2P video service platform 20 implies definitely a hike in the rate of data streaming, and thus the video quality through the streaming can be better ensured.

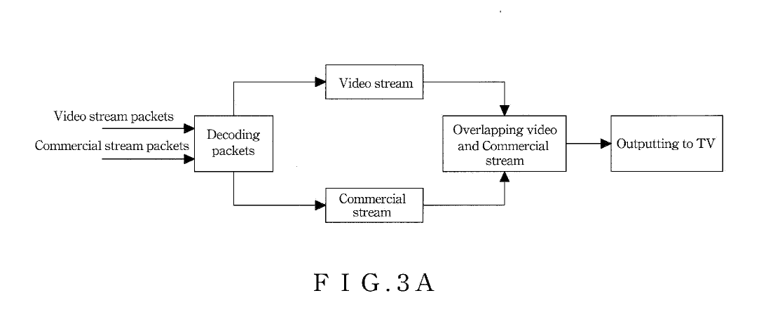

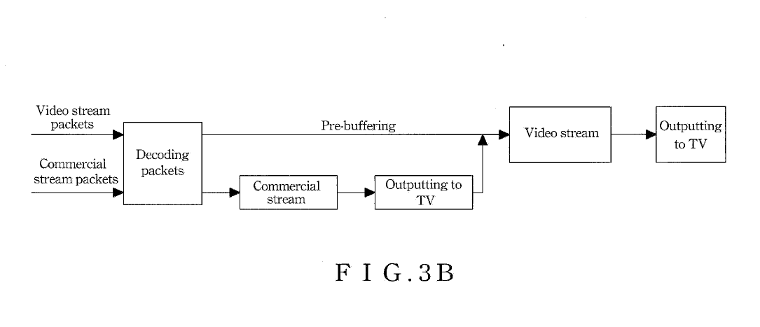

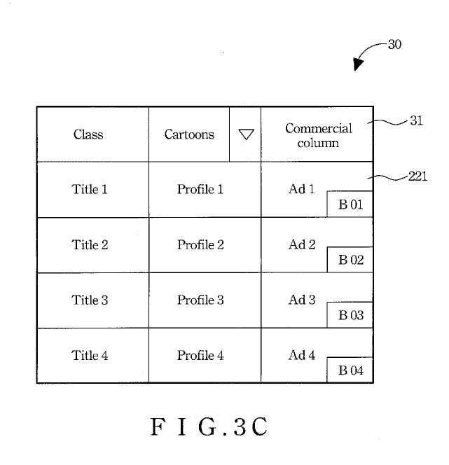

The commercial server 22, as another server capable of data streaming similar to the aforesaid video server 21, includes at least a commercial stream 221, which can be segmented and zipped into a plurality of packets by a stream encoding module 223. The packets can then be transmitted to the computer 23 or any of the peers 24 in a streaming pattern by a stream transmitting module 225. The major difference between the video server 21 and the commercial server 22 is that the commercial server 22 can transmit the commercial stream 221 to the computer 23 or the peers 24 automatically, while the video server 21 can transmit the video stream 211 only upon a request from the computer 23 or the user. FIG. 3A to FIG. 3C show the display of the commercial stream 221.

The network video decoder 25, connected with the computer 23 via a local network, is to control the computer 23 to download the packets from the P2P network platform 20, to have the computer 23 forward the downloaded packets to the network video decoder 25, and finally to unzip and play the video stream. In the present invention, each of the packets can include a segment of the video stream 211 and a segment of the commercial stream 221. The television 26 is electrically coupled with the network video decoder 25, such that the user can play the video stream 211 as well as the commercial stream 221 on the screen of the television 26.

Referring now to FIG. 3A, overlapping display of the video stream 211 and the commercial stream 221 in accordance with the present invention is shown. To promote the commercial stream 221 without degrading the display quality of the video stream 211, the network video decoder 25 firstly unzips the received packets to form the video stream 211 and the commercial stream 221, and then overlaps, by a crystal or semi-transparent way, the display of the commercial stream 221 on top of the display of the video stream 211. Upon such an arrangement, the commercial stream 221 and the video stream 211 can be displayed simultaneously on the same TV screen. Preferably, the commercial stream 221 can be played in a traffic line way flowing along a specific side of the display screen.

Referring now to FIG. 3B, it shows how the commercial stream 221 can be displayed on the TV screen in accordance with the present invention, while in buffering the video stream 211. For the size of the video stream 211 is usually larger than that of an ordinary commercial stream 221, a much longer time in pre-buffering the video stream 221 is needed. During the pre-buffering period, the video stream 221 is unable to be shown on the TV screen. However, in the mean time, the network video decoder 25 can still automatically display the commercial video 221 on the TV screen.

Referring now to FIG. 3C, a typical electronic program list in accordance with the present invention is shown. In the present invention, when the number of the participants with the P2P video service platform 20 increases, it can be foreseen that more video streams 211 can be available in the network. To facilitate the search of a specific video stream 211, the P2P video service platform 20 of the present invention can further include the electronic program list 30. As soon as a computer 23 is successfully connected with the P2P video service platform 20, the electronic program list 30 as well as the commercial stream 221 would be automatically provided to the newcomer computer 23. As noted, the commercial stream 221 can be shown to a commercial column 31 of the electronic program list 30. Preferably, the class of the commercial stream 221 is better to meet possible audients of the program list 30. Upon such an arrangement, when a user goes over the electronic program list 30, the commercial stream 221 can be simultaneously presented to the user.

Referring back to FIG. 2, to ease the operation of the present system, a remote control 27 can be provided to control the network video decoder 25. Except for performing a traditional TV remote control, the remote control 27 of the present invention can further provide a plurality of hot keys 271 to be in charge of some specific commands from the network video decoder 25 to the computer 23. Those commands can include a command of entering the electronic program list 30 of the P2P video service platform 20, a command of displaying the selected program in the electronic program list 30, and so on.

In the present invention, each of the commercial streams 221 in the commercial server 22 can have a commercial code (for example, B01 in FIG. 3C). In the case that a TV user is interested in a specific product promoted by a commercial stream 221 on the TV 26, he/she can use the remote control 27 to enter the respective commercial code (say, B01) and then press a corresponding hot key 271 to have the network video decoder 25 notify the related commercial server 22 through the computer 23. The related commercial server 22 can then respond to issue an email related to the corresponding commercial stream 221 to an email address preset by the TV user.

While the present invention has been particularly shown and described with reference to a preferred embodiment, it will be understood by those skilled in the art that various changes in form and detail may be without departing from the spirit and scope of the present invention.

I claim:

1. A network video system for a television to broadcast a computer network video program, comprising:
a peer-to-peer (P2P) video service platform, further including at least a video server, at least a commercial server, and a plurality of peers, in which the video server provides plural video streams and the commercial server provides plural commercial streams;
a computer, forming a P2P network connection with the P2P video service platform, to download at least one of the video streams from one of the video server and the peers, and to download at least one of the commercial streams from the commercial server;
a network video decoder, forming a local network connection with the computer, to receive the video streams and the commercial streams downloaded to the computer; and
a television, coupled electrically with the network video decoder, to display the video streams and the commercial streams received by the network video decoder.

2. The network video system for a television to broadcast a computer network video program according to claim 1, wherein said commercial streams is simultaneously displayed in a semi-transparent way to overlap said video streams.

3. The network video system for a television to broadcast a computer network video program according to claim 1, wherein said commercial streams are played in said television while said network video decoder pre-buffers said video streams.

4. The network video system for a television to broadcast a computer network video program according to claim 1, wherein said video server further includes an electronic program list to be provided automatically to said computer and then to be displayed in the television through said network video decoder as soon as said computer is connected with said P2P video service platform.

5. The network video system for a television to broadcast a computer network video program according to claim 4, wherein said electronic program list further includes a commercial column for displaying a specific one of said commercial streams corresponding to a displaying one of said video streams.

6. The network video system for a television to broadcast a computer network video program according to claim 1, further including a remote control for issuing a command to said network video decoder to control said computer in downloading said video streams from said video server.

7. The network video system for a television to broadcast a computer network video program according to claim 6, wherein each of said commercial streams is assigned by a respective commercial code to be entered by said remote control by accompanying a command to said network video decoder; wherein, upon said network video decoder receives the commercial code and the command, said commercial server related to the commercial code is then in response to issue an email related to the corresponding commercial stream to a preset email address.

8. The network video system for a television to broadcast a computer network video program according to claim 1, wherein said video server further includes a stream encoding module to divide each of said video streams into a plurality of packets having individual serial numbers and a stream transmitting module to orderly transmit the packets in a streaming way.

9. The network video system for a television to broadcast a computer network video program according to claim 8, wherein said computer orderly receives said packets and directly forwards said packets to said network video decoder for stream broadcasting.

10. The network video system for a television to broadcast a computer network video program according to claim 1, wherein said video streams includes an online video stream and a pre-recorded video stream.

11. A network video system for a television to broadcast a computer network video program, comprising:
a peer-to-peer (P2P) video service platform, further including at least a video server and a plurality of peers, in which the video server provides plural video streams;
a computer, forming a P2P network connection with the P2P video service platform, to download at least one of the video streams from one of the video server and the peers;
a network video decoder, forming a local network connection with the computer, to receive the video streams downloaded to the computer; and
a television, coupled electrically with the network video decoder, to display the video streams received by the network video decoder.

12. The network video system for a television to broadcast a computer network video program according to claim 11, wherein said video server further includes an electronic program list to be provided automatically to said computer and then to be displayed in the television through said network video decoder as soon as said computer is connected with said P2P video service platform.

13. The network video system for a television to broadcast a computer network video program according to claim 11, further including a remote control for issuing a command to said network video decoder to control said computer in downloading said video streams from said video server.

14. The network video system for a television to broadcast a computer network video program according to claim 11, wherein said video server further includes a stream encoding module to divide each of said video streams into a plurality of packets having individual serial numbers and a stream transmitting module to orderly transmit the packets in a streaming way.

15. The network video system for a television to broadcast a computer network video program according to claim 11, wherein said computer orderly receives said packets and directly forwards said packets to said network video decoder for stream broadcasting.

16. The network video system for a television to broadcast a computer network video program according to claim 11, wherein said video streams includes an online video stream and a pre-recorded video stream.
